(19) United States
(12) Patent Application Publication
(10) Pub. No.: US 2018/0154850 A1
(43) Pub. Date: Jun. 7, 2018

(54) SYSTEM AND METHOD FOR AVOIDING COLLISION BETWEEN VEHICLES

(71) Applicants: Emma Yates, Pasadena, CA (US); Sarah Yates, Pasadena, CA (US)

(72) Inventors: Emma Yates, Pasadena, CA (US); Sarah Yates, Pasadena, CA (US)

(21) Appl. No.: 15/829,711

(22) Filed: Dec. 1, 2017

Related U.S. Application Data
(60) Provisional application No. 62/429,030, filed on Dec. 1, 2016.

(51) Int. Cl. B60R 21/0134; G08G 1/16

(52) U.S. Cl. CPC B60R 21/0134; B60R 2021/01013; G08G 1/162

(57) ABSTRACT

A collision avoidance system for vehicles is presented. The system includes at least one sensor for determining proximity information such as speed, direction and distance of one or more other vehicles in close proximity to a subject vehicle, a computer system for processing the proximity information to determine if collision is imminent between the subject vehicle and one or more of the other vehicles. The subject vehicle and the other vehicles with which collision is imminent have at least one electromagnet that can be activated to prevent or minimize the impending collision. The collision avoidance system may be coupled with the subject vehicle's engine control and the braking control to provide additional collision avoidance protection in addition to the repelling force resulting from activating the electromagnets of the subject vehicle and the one or more of other vehicles per the method of the invention.

### CROSS-REFERENCE TO RELATED APPLICATIONS

The present application claims the benefit of U.S. Provisional Application Ser. No. 62/429,030, filed on Dec. 1, 2016, the specification of which is herein incorporated by reference for completeness of disclosure.

### BACKGROUND OF THE INVENTION

### Field of the Invention

Embodiments of the invention relate to the field of collision avoidance systems. More specifically, the invention relates to a system and method for preventing or minimizing collision between vehicles.

### Description of the Related Art

Preventing vehicle collisions is a long-standing problem for the transportation industry and everyone who relies on vehicles for transportation. Collisions may be the result of driver error, equipment failure, or environmental factors. Significant time and resources have been expended on developing safety systems to reduce the risk of vehicle collisions. For example, air bags in vehicles can soften the impact of collision, and proximity warning systems alert vehicle operators of potential collisions. Some collision avoidance systems actually stop a vehicle by automatically applying the brakes, and others override driver control by intervening with fuel or steering control systems.

Generally, in such prior art systems, once a certain threshold is reached, a collision alert is issued. If the driver ignores the alert or fails to respond, the system then employs automatic braking or steering. Such systems supplement the human driver with an automated control system. Despite the utility and benefits of such systems, there are still vulnerabilities and limitations. For example, known systems can be undermined by environmental conditions such as snow, rain, oil slicks, driver error from a human driver in a second vehicle, and an inability to communicate with a second vehicle that is creating the risk of a collision.

Thus, there is a need for a system that can prevent or minimize collision between vehicles, which relies on more than automatic intervention in the vehicle's braking, fuel, and/or steering systems.

### BRIEF SUMMARY OF THE INVENTION

One or more embodiments of the invention are directed to a collision avoidance system and method for preventing or minimizing collision between vehicles. One embodiment of the invention uses magnetic fields to prevent or minimize collision between vehicles. The invention comprises measuring and collecting proximity information or data about vehicles that may collide, such as velocity, position, and distance. The collected proximity information may be measured by one or more sensors, including but not limited to known position sensors, cameras, speed sensors, acceleration sensors, sonar, radar, Light Detection and Ranging (“LIDAR”).

In one or more embodiments, the collected information is used by a specially programmed computer to determine if collision is imminent with one or more other vehicles in close proximity to a subject vehicle. It may also determine which part(s) of the subject vehicle is likely to be impacted based on the collected information, which is updated in real-time.

The system of the subject vehicle determines whether the other vehicle with which collision is imminent has a compatible collision avoidance system. In one or more embodiments, the inventive system comprises one or more electromagnets mounted in the vehicle for the specific purpose of creating a repelling force to prevent collision with the other vehicle. The one or more electromagnets could be fixed or movable within the vehicle.

If the one or more vehicles with which collision is imminent does not have a compatible collision avoidance system, the system of the subject vehicle will not create a magnetic force, but instead can sound an alarm and/or work in conjunction with other collision avoidance features in the vehicle, such automatic braking or steering.

If the subject vehicle and the one or more other vehicles with which collision is imminent have compatible collision avoidance systems, the systems in each vehicle create magnetic fields that will repel each other (i.e., like poles repel), and the magnetic forces between the vehicles can prevent a collision or significantly minimize the impact.

### BRIEF DESCRIPTION OF THE DRAWINGS

The above and other aspects, features and advantages of the invention will be more apparent from the following more particular description thereof, presented in conjunction with the following drawings wherein:

FIG. 1 is an overview of a vehicle with systems and components of a collision avoidance system in accordance with one or more embodiments of the present invention.

FIG. 2 is an overview of an electromagnet for use with the collision avoidance system in accordance with one or more embodiments of the present invention.

FIG. 3 is an illustration of an operation of the collision avoidance system with multiple vehicles in an impending frontal and rear collision in accordance with one or more embodiments of the present invention.

FIG. 4 is an illustration of an operation of the collision avoidance system with impending sideways swipe in accordance with one or more embodiments of the present invention.

FIG. 5 is an illustration of an operation of the collision avoidance system with impending T-bone collision in accordance with one or more embodiments of the present invention.

FIG. 6 illustrates a general-purpose computer and peripherals that when programmed as described herein may operate as a specially programmed computer capable of implementing one or more methods, apparatus and/or systems of the present invention.

FIG. 7 is a flowchart illustration of an exemplary process for controlling the collision avoidance system in accordance with one or more embodiments of the present invention.

### DETAILED DESCRIPTION

The present invention, comprising a system and method for preventing or minimizing collision between vehicles, will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. It should be noted that although examples of the invention are set forth herein, the claims, and the full scope of any equivalents, are what define the metes and bounds of the invention.

For a better understanding of the disclosed embodiment, its operating advantages, and the specified objects attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

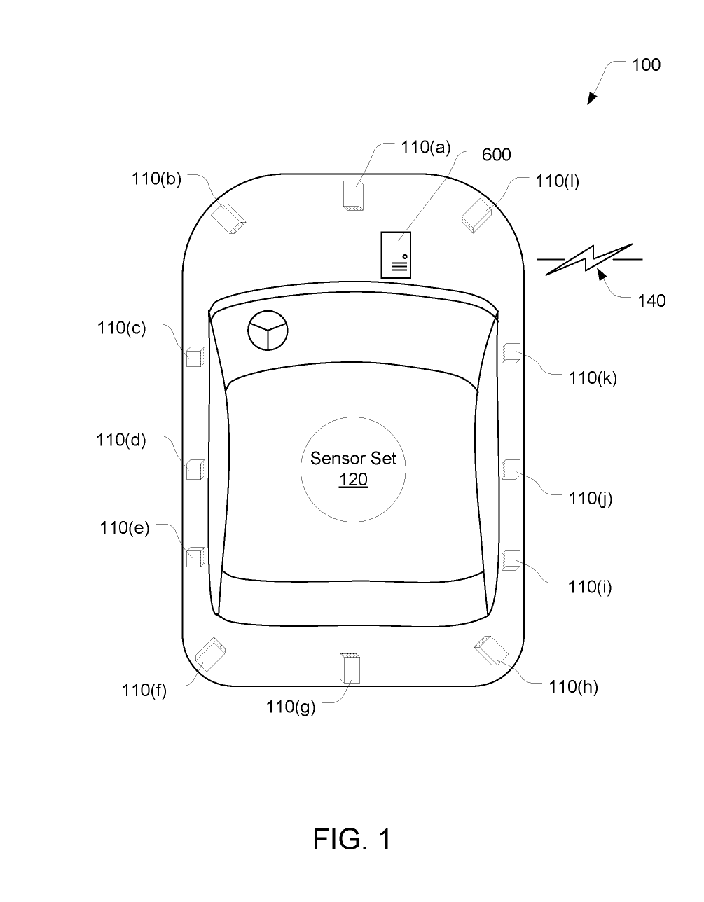

One or more embodiments of the present invention will now be described with references to FIGS. 1-7.

Now with reference to FIG. 1, one or more embodiments of the present invention comprises a vehicle 100 with one or more electromagnets 110 (shown as 110(a) to 110(l)); sensor set 120 for sensing other relative objects; computer 600 for controlling the electromagnets; and wireless communication infrastructure 140. Vehicle 100 may be any landcraft, aircraft, or watercraft, including but not limited to an automobile, motorcycle, train, ship, submarine, aircraft, drone, etc.

Vehicle 100 may be configured with electromagnets 110 mounted fully around its perimeter, or configured with electromagnets just in the areas such as the front and rear bumpers. In addition to having multiple separate electromagnets, a single electromagnet could be configured to function as multiple separate electromagnets, wherein certain portions of the electromagnetic can be selectively activated. The electromagnets can also have fixed positions or movable or rotatable positions. Those of skill in the art would appreciate that the desired configuration of the electromagnet installation can be adjusted and customized based on vehicle size and weight, and the intended purpose of the vehicle.

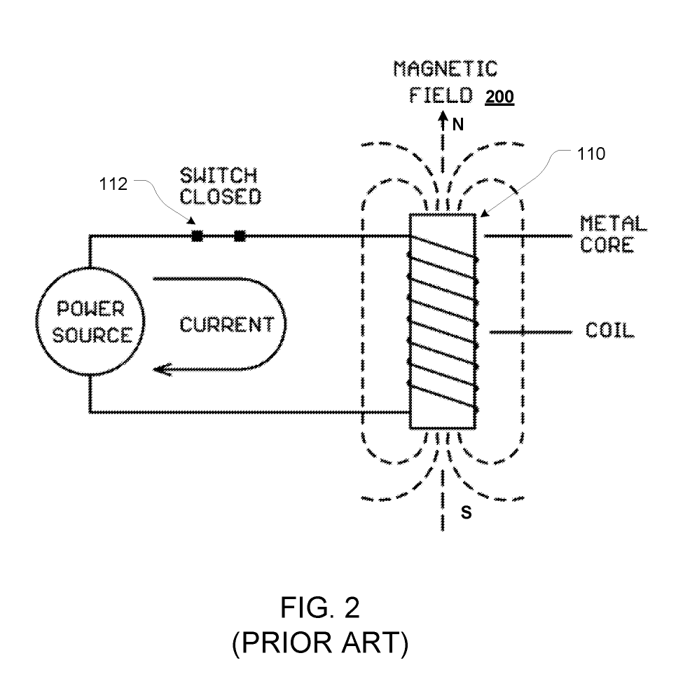

Now, with reference to FIG. 2, which is an illustration of a prior art electromagnet that can be suitably used with the collision avoidance system in accordance with one or more embodiments of the present invention. Each electromagnet is coupled to a power source, e.g. the vehicle's battery or capacitor bank, and includes a switch 112 that is controllable by computer 600. When switch 112 is closed, current flows through the electromagnet 110 and magnetic field 200 is generated. When switch 112 is open, current stops flowing and the magnetic field ceases to exist. It is understood that alternative electromagnets, and systems for generating a magnetic field, can be used with the present invention.

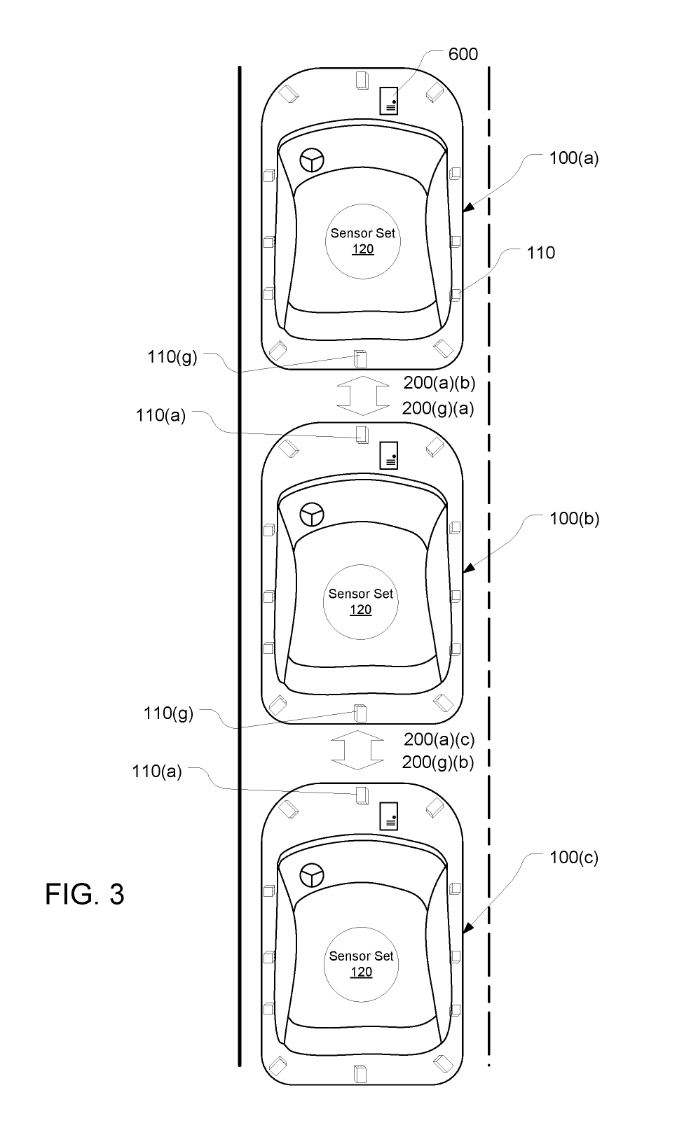

As illustrated in FIG. 1, vehicle 100 comprises one or more sensor set 120. The sensor set 120 can measure and determine parameters such velocity (i.e. speed and direction), distance, and location for the subject vehicle and other vehicles in the vicinity of the subject vehicle. For instance, in FIG. 3, assuming the subject vehicle is 100(b), then its sensor set 120 can measure and determine the locations and velocities (as well as other desired parameters) of vehicles 100(a) and 100(c), wherein the information collected by the sensor set is used by the computer 600 of vehicle 100(b). The computer is then able to determine in real-time whether a collision is imminent/impending between the subject vehicle 100(b) and vehicle 100(a) and/or vehicle 100(c).

The sensor 120 set may comprises one or more of speed sensors, acceleration sensors, sonar, radar, Light Detection and Ranging (“LIDAR”), cameras, and other known sensing devices for gathering information about the subject vehicle and other vehicles that are within a measurable distance from the subject vehicle. Further, one or more sensors may be used to gather information about driving conditions such as road conditions including coefficient of friction, oil slicks, water slicks, humidity, visibility, etc.

In one or more embodiments of the invention, one or more sensors of the sensor set 120 may be placed at different locations around the vehicle 100, depending on the desired information to be collected and measured. For instance, a LIDAR may be placed on top of the vehicle and/or one or more radars may be placed around the vehicle for detecting objects in the vicinity of the subject vehicle. Those of skill in the art would appreciate that the sensor set may be a combination of different sensors and part of different systems in the vehicle. For example, it may be desirable to use sensors from other safety systems in the vehicle for the purpose of implementing the present collision avoidance system.

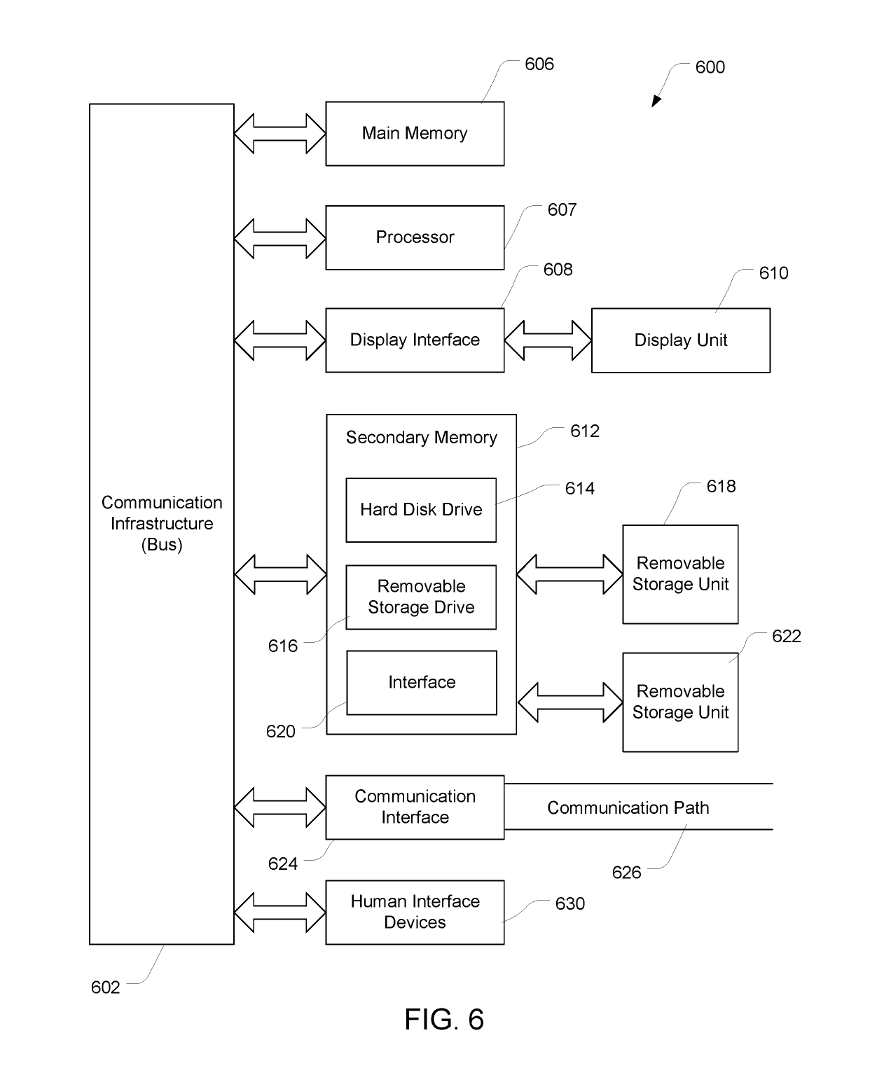

Vehicle 100 further includes a computer for processing and controlling the collision avoidance system functions. FIG. 6 is an illustration of a computer and peripherals, which when programmed as described herein, may operate as a specially programmed computer 600 capable of implementing one or more methods, apparatus and/or systems of the solution described in this disclosure. Processor 607 may be coupled to bi-directional communication infrastructure 602. Communication infrastructure 602 may generally be a system bus that provides an interface to the other components in the general-purpose computer system such as processor 607, main memory 606, display interface 608, secondary memory 612 and/or communication interface 624.

Main memory 606 may provide a computer readable medium for accessing and executing stored data and applications. Display interface 608 may communicate with display unit 610 that may be utilized to display outputs to the user of the specially-programmed computer system. Display unit 610 may comprise one or more monitors that may visually depict aspects of the computer program to the user. Main memory 606 and display interface 608 may be coupled to communication infrastructure 602, which may serve as the interface point to secondary memory 612 and communication interface 624. Secondary memory 612 may provide additional memory resources beyond main memory 606, and may generally function as a storage location for computer programs to be executed by processor 607. Either fixed or removable computer-readable media may serve as secondary memory 612. Secondary memory 612 may comprise, for example, hard disk 614 and removable storage drive 616 that may have an associated removable storage unit 618. There may be multiple sources of secondary memory 612 and systems implementing the solutions described in this disclosure may be configured as needed to support the data storage requirements of the user and the methods described herein. Secondary memory 612 may also comprise interface 620 that serves as an interface point to additional storage such as removable storage unit 622. Numerous types of data storage devices may serve as repositories for data utilized by the specially programmed computer system. For example, magnetic, optical or magnetic-optical storage systems, or any other available mass storage technology that provides a repository for digital information may be used.

Communication interface 624 may be coupled to communication infrastructure 602 and may serve as a conduit for data destined for or received from communication path 626. A network interface card (NIC) is an example of the type of device that once coupled to communication infrastructure 602 may provide a mechanism for transporting data to communication path 626. Computer networks such Local Area Networks (LAN), Wide Area Networks (WAN), Wireless networks, optical networks, distributed networks, the Internet or any combination thereof are some examples of the type of communication paths that may be utilized by the specially programmed computer system. Communication path 626 may comprise any type of telecommunication network or interconnection fabric that can transport data to and from communication interface 624.

To facilitate user interaction with the specially programmed computer system, one or more human interface devices (HID) 630 may be provided. Some examples of HIDs that enable users to input commands or data to the specially programmed computer may comprise a keyboard, mouse, touch screen devices, microphones or other audio interface devices, motion sensors or the like, as well as any other device able to accept any kind of human input and in turn communicate that input to processor 607 to trigger one or more responses from the specially programmed computer, are within the scope of the system disclosed herein.

While FIG. 6 depicts a physical device, the scope of the system may also encompass a virtual device, virtual machine or simulator embodied in one or more computer programs executing on a computer or computer system and acting or providing a computer system environment compatible with the methods and processes of this disclosure. In one or more embodiments, the system may also encompass a cloud computing system or any other system where shared resources, such as hardware, applications, data, or any other resources are made available on demand over the Internet or any other network. In one or more embodiments, the system may also encompass parallel systems, multi-processor systems, multi-core processors, and/or any combination thereof. Where a virtual machine performs substantially similarly to that of a physical computer system, such a virtual platform will also fall within the scope of disclosure provided herein, notwithstanding the description herein of a physical system such as that in FIG. 6.

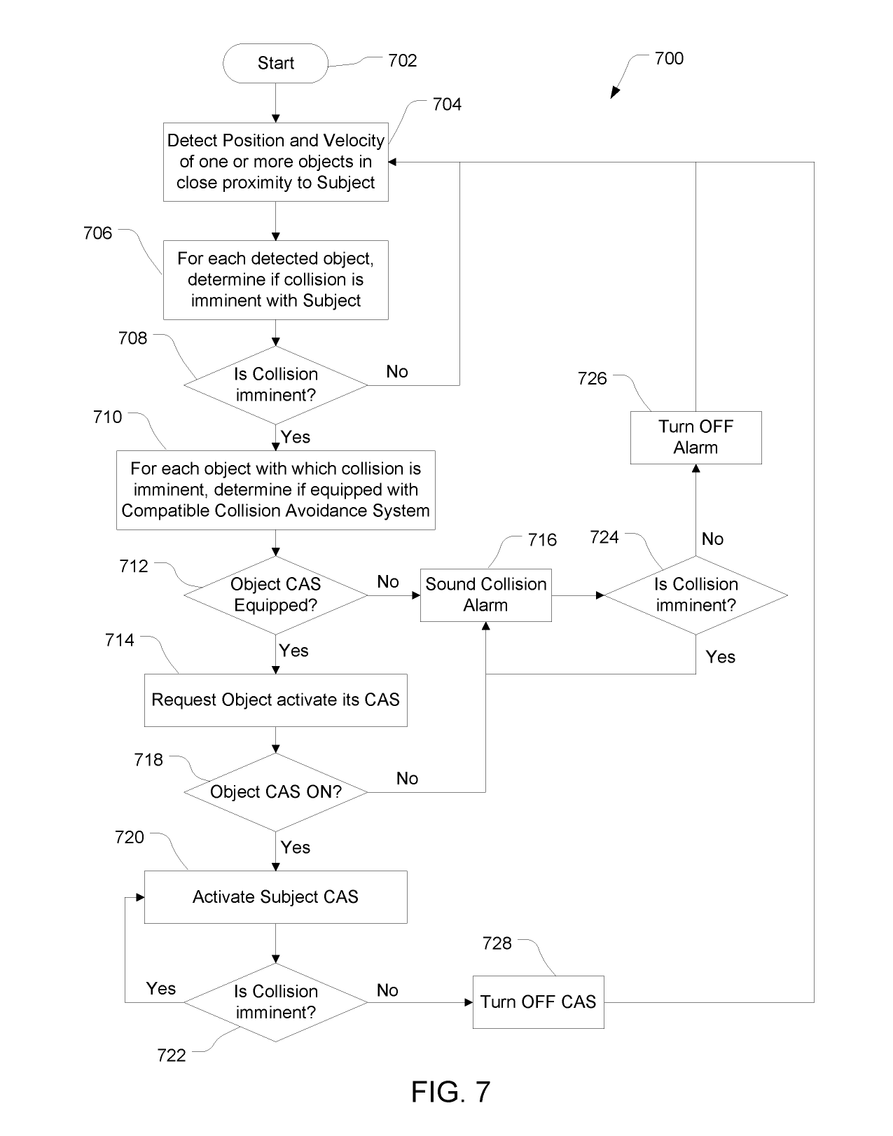

FIG. 7 is a flowchart illustration of an exemplary process 700 for controlling the collision avoidance system (“CAS”) in accordance with one or more embodiments of the present invention. The process begins at step 702. At step 704, the sensor set 120 detects the positions and velocities of one or more vehicles in close proximity to the subject vehicle. For instance, in FIG. 3, the sensor set in vehicle 100(b) detects vehicle 100(a) and 101(c), and in block 706, the information collected from the sensors enables computer 600 to determine whether the subject vehicle is likely to collide with either vehicle 100(a) and/or vehicle 100(c). Also, the likely point of impact with subject vehicle 100(b) may be computed/determined as well.

Similar computation to determine whether collision is imminent and the point of impact may be carried out for every vehicle that was detected in step 704. For instance, computation to determine if collision with vehicle 100(a) is imminent is being carried out concurrently as determining if collision with vehicle 100(c) is imminent.

If collision is not imminent with any of the detected vehicles, the process returns to get more information from sensor set 120, at step 704. Of course, the sensors are scanning in real-time and the information on each object in close proximity is being continuously updated.

If the system determines that collision is likely/imminent, it communicates with the one or more vehicles with which collision is imminent, in step 710, to determine if they are equipped with compatible collision avoidance system. Communication may be wirelessly through wireless communication infrastructure 140. Alternatively, the determination step 710 can be performed concurrently with or prior to step 704, wherein the subject vehicle detects whether nearby vehicles are equipped with a compatible collision avoidance system. To be clear, the determination of whether vehicles contain compatible collision avoidance systems can be achieved through a communication system or a sensor system that does not require communication, but instead relies on the transmission and reception of measurable signals.

In a preferred implementation, the subject vehicle and any nearby vehicle will each be equipped with the collision avoidance system of this invention, such that each vehicle is the subject vehicle for purposes of the system and method described herein. In other words, each of the vehicles in proximity with each other will be performing the same measurements and determinations, and will activate their respective magnetic fields when appropriate in order to prevent or minimize a collision.

If in step 712 the computer in the subject vehicle determines that one or more of the vehicles with which collision is imminent is not equipped with a compatible collision avoidance system, it may sound an alarm to the operator of the vehicle at step 716. The system may continue sounding the alarm so long as the collision remains imminent, as determined in step 724. Otherwise, the system turns off the alarm in step 726 and returns back to step 704 to restart the process. To be clear, the system can work in conjunction with other safety and collision avoidance functionality in the vehicle, such as automatic braking and steering systems.

If in step 712 the computer in the subject vehicle determines that the one or more vehicles with which collision is imminent is equipped with a compatible collision avoidance system, then it proceeds to step 720 where it requests for the one or more vehicles with which collision is imminent to activate their collision avoidance system. In a preferred embodiment, each one of the vehicles with which collision is imminent is equipped with a compatible collision avoidance system, thus is making the same determination of impending collision.

In step 718, the subject vehicle receives confirmation that the collision avoidance system is enabled in the other vehicles, i.e. the one or more vehicles with which collision is imminent, such as vehicles 100(a) and 100(c) in FIG. 3. The subject vehicle 100(b) then activates its electromagnets at step 720. The system continues with engagement of the electromagnets (as indicated by return to block 720 from block 722) so long as the collision remains imminent, as determined in step 722. Otherwise, the system turns off the electromagnets in step 728 and returns back to step 704 to restart the process.

The one or more electromagnets that are activated, in all the vehicles involved in the impending collision, are the ones near the point of likely/imminent impact between the two or more vehicles involved in the impending collision. The strength and force of the magnetic field generated by the electromagnets can be controlled to accomplish the desired goal of repelling the vehicles that are on course to collide.

In the scenario of FIG. 3, assume that subject vehicle 100(b) is likely to collide with both vehicle 100(a) and vehicle 100(c), and all three vehicles contain the present collision avoidance system. In that scenario, all three vehicles would activate electromagnets near points of imminent collision, which would result in repelling forces between the vehicles.

In the illustrations of FIGS. 3-5, the magnetic force from each electromagnet in each specific vehicle is represented using the symbol “200(Electromagnet)(Vehicle Designation).” Thus, for example, “200(g)(a)” means magnetic force from electromagnet 110(g) of vehicle 100(a).

More specifically, with regard to an imminent collision between subject vehicle 100(b) and vehicle 100(a), vehicle 100(a) would activate its electromagnet 110(g) thereby generating magnetic force 200(g)(a), which would repel against magnetic force 200(a)(b) generated by electromagnet 110(a) of subject vehicle 100(b). With regard to an imminent collision between subject vehicle 100(b) and vehicle 100(c), vehicle 100(c) would activate its electromagnet 110(a) thereby generating magnetic force 200(a)(c), which would repel against magnetic force 200(g)(b) generated by electromagnet 110(g) of subject vehicle 100(b). The electromagnets in the subject vehicle, and all vehicles with a compatible crash avoidance system, will face the same direction (e.g., North), so that when the vehicles are approaching each other, the magnetic forces from their respective electromagnets will repel each other, thereby preventing or minimizing a collision.

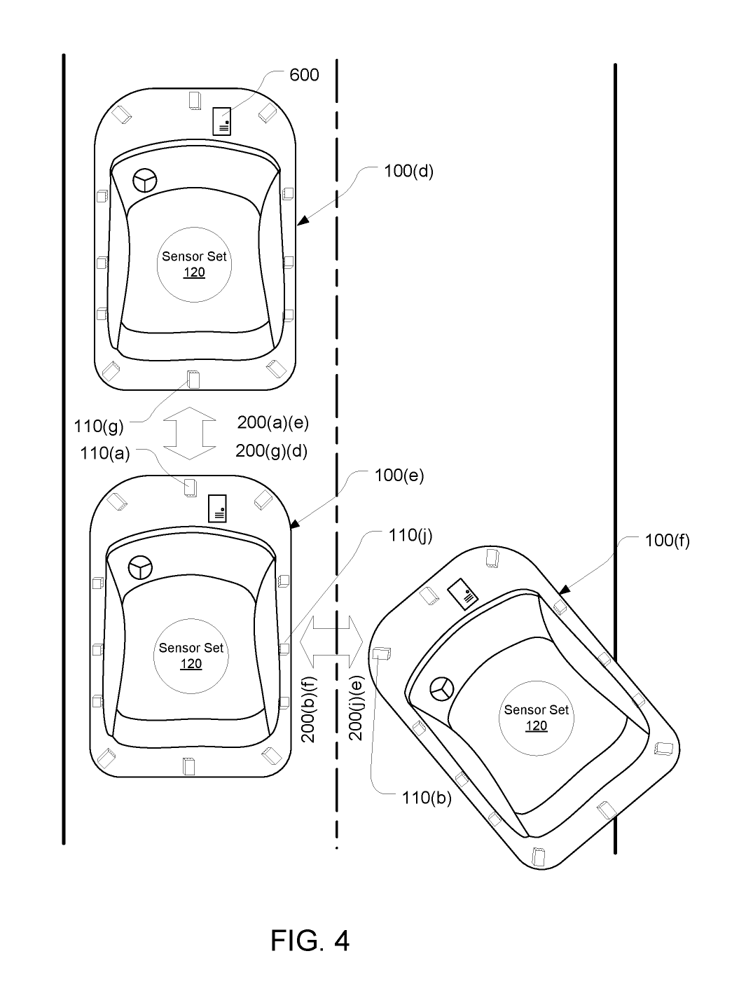

In the scenario of FIG. 4, assume that subject vehicle 100(e) is likely to collide with both vehicle 100(d) and vehicle 100(f), and all three vehicles contain the present collision avoidance system. In that scenario, all three vehicles would activate electromagnets near points of imminent collision, which would result in repelling forces between the vehicles.

More specifically, with regard to an imminent collision between subject vehicle 100(e) and vehicle 100(d), vehicle 100(d) would activate its electromagnet 110(g) thereby generating magnetic force 200(g)(d), which would repel against magnetic force 200(a)(e) generated by electromagnet 110(a) of subject vehicle 100(e). With regard to an imminent collision between subject vehicle 100(e) and vehicle 100(f), vehicle 100(f) would activate its electromagnet 110(b) thereby generating magnetic force 200(b)(f), which would repel against magnetic force 200(j)(e) generated by electromagnet 110(j) of subject vehicle 100(e). The electromagnets in the subject vehicle, and all vehicles with a compatible crash avoidance system, will face the same direction (e.g., North), so that when the vehicles are approaching each other, the magnetic forces from their respective electromagnets will repel each other, thereby preventing or minimizing a collision.

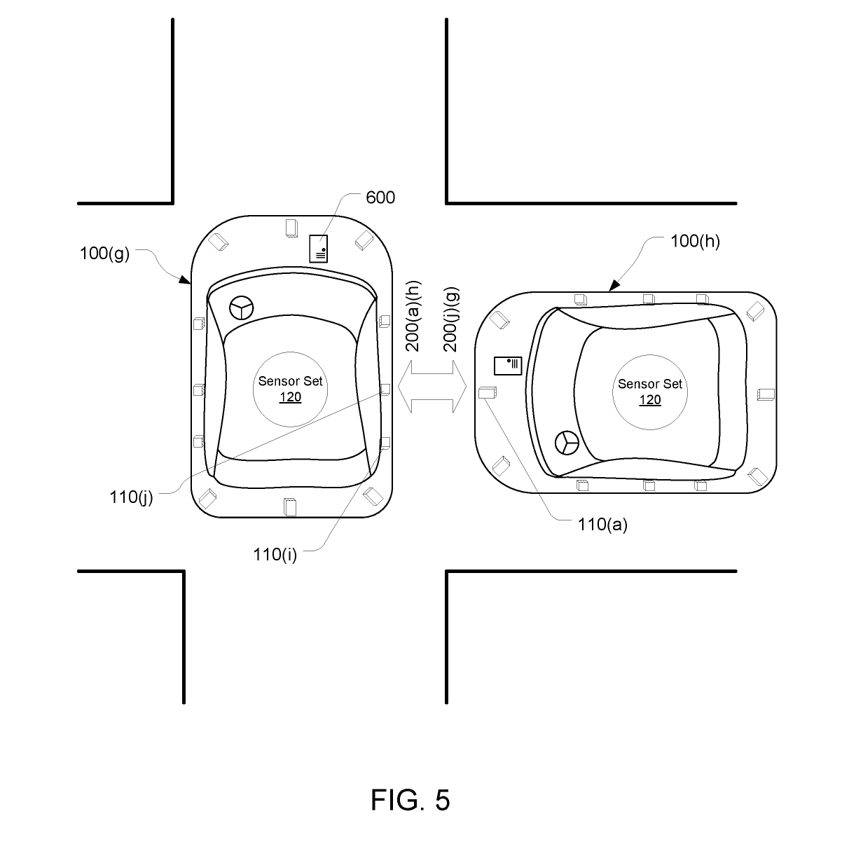

In the scenario of FIG. 5, assume that subject vehicle 100(g) is likely to collide with vehicle 100(h), and both vehicles contain the present collision avoidance system. In that scenario, both vehicles would activate electromagnets near points of imminent collision, which would result in repelling forces between the vehicles.

More specifically, with regard to an imminent collision between subject vehicle 100(g) and vehicle 100(h), vehicle 100(h) would activate its electromagnet 110(a) thereby generating magnetic force 200(a)(h), which would repel against magnetic force 200(j)(g) generated by electromagnet 110(j) of subject vehicle 100(g). The collision avoidance systems of subject vehicle 100(g) and vehicle 100(h) could also activate additional electromagnets. For example, in subject vehicle 100(g), electromagnets 100(i) and 100(k) could be activated, and in vehicle 100(h), electromagnets 110(b) and 110(l) could be activated. The electromagnets in the subject vehicle, and all vehicles with a compatible crash avoidance system, will face the same direction (e.g., North), so that when the vehicles are approaching each other, the magnetic forces from their respective electromagnets will repel each other, thereby preventing or minimizing a collision.

The disclosed invention contemplates the ability to use different sizes and shapes of electromagnets, as well as varied placement. For example, with regard to the example depicted in FIG. 5, the subject vehicle 100(g) may include electromagnets covering the entire side of the vehicle, with an electromagnet having a length that matches the length of the vehicle door, and separate electromagnets having lengths that correspond to side panels and bumpers. And, as shown by the scenarios in FIGS. 3-5, multiple electromagnets can be activated at the same time, in order to accommodate multiple collisions/impacts.

Another embodiment of the invention creates a perimeter of electromagnets around the vehicle, so that very little space is let between adjacent electromagnets. The electromagnets can be hidden from view, by being mounted beneath the exterior body panels of the vehicle.

In a preferred implementation, the electromagnets are positioned at a standardized height and distance from the ground, in all vehicles having compatible collision avoidance systems. For example, in the instance of automobiles, it would be desirable for all automobiles to have bumpers at approximately the same height, and to have electromagnets positioned inside the area of the bumpers and along the entire perimeter of the automobile. Such placement would ensure that all vehicles equipped with the collision avoidance system will collide at the same height. This avoids such problems as having the bumper of one automobile collide with the height of a passenger's head in another vehicle. For maximum benefit of the disclosed invention, all automobiles would be required by law or regulation to be manufactured with the present collision avoidance system, and with the same technical parameters, including height, spacing, power of electromagnets, etc. Over time, the chances of colliding with an automobile that lacks the collision avoidance system will decrease, and riding in an automobile will be much safer for everyone.

The present invention is understood to have applicability to any category of vehicle, and is not limited to automobiles. Any type of vehicle that faces a risk of colliding with another vehicle, whether on land, water, or air, can benefit from the system and method disclosed herein.

While the invention herein disclosed has been described by means of specific embodiments and applications thereof, numerous modifications and variations could be made thereto by those skilled in the art without departing from the scope of the invention set forth in the claims.

What is claimed is:

1. A collision avoidance system for a vehicle comprising:
at least one sensor that collects proximity information for a subject vehicle in relation to at least one other vehicle;
a processing unit that uses the proximity information to determine whether a collision is imminent between the subject vehicle and the at least one other vehicle; and
at least one electromagnet positioned in each of the subject vehicle and the at least one other vehicle, wherein the electromagnet is activated upon a determination that collision is imminent between the subject vehicle and the at least one other vehicle.

2. The collision avoidance system of claim 1, wherein the proximity information includes one or more of the velocity of the subject vehicle, the velocity of the at least one other vehicle, and the distance between the subject vehicle and the at least one other vehicle.

3. The collision avoidance system of claim 1, wherein the activation of the electromagnet produces a magnetic field between the subject vehicle and the at least one other vehicle that reduces an impact from collision.

4. The collision avoidance system of claim 1, wherein the activation of the electromagnet produces a magnetic field between the subject vehicle and the at least one other vehicle that prevents collision.

5. The collision avoidance system of claim 1, wherein the electromagnet from each of the subject vehicle and the at least one other vehicle produces a magnetic field with like polarity, wherein the magnetic fields repel each other.

6. The collision avoidance system of claim 1, wherein said processing unit determines a portion of the subject vehicle that will imminently collide with the at least one other vehicle, and activates one or more electromagnets positioned in that portion of the subject vehicle.

7. The collision avoidance system of claim 6, wherein the electromagnet in the at least one other vehicle is activated such that the imminent collision between the subject vehicle and the at least one other vehicle is reduced or prevented.

8. An collision avoidance system for a vehicle comprising:
at least one sensor for obtaining information comprising proximity data between a first vehicle and a second vehicle;
a processing unit for processing said information from the sensor and determining if collision is imminent between the first vehicle and the second vehicle;
a communication system for the processing unit to communicate with the second vehicle to activate a compatible collision avoidance system; and
at least one electromagnet positioned in each of the first and the second vehicles, wherein the processing unit activates the electromagnet in the first vehicle upon determination that collision is imminent and upon confirmation of activation of the electromagnet in the second vehicle by the compatible collision avoidance system in the second vehicle.

9. The collision avoidance system of claim 8, wherein the sensor is located on a third object external to said first and second vehicles.

10. The collision avoidance system of claim 8, wherein the electromagnet in the first and second vehicles are magnetized to create a repelling force between the first and second vehicles thereby preventing collision or minimize damage from collision.

11. The collision avoidance system of claim 8, wherein the communication system is wireless.

12. A method of preventing collision between vehicles comprising:
obtaining velocity and location of a subject vehicle and one or more other vehicles in close proximity to the subject vehicle;
determining if collision is imminent between the one or more other vehicles and the subject vehicle using the velocity and location information;
determining if the one or more other vehicles have a compatible collision avoidance system, if collision is imminent;
enabling one or more electromagnets in the subject vehicle and the one or more other vehicles to create a repelling force between the subject vehicle and the one or more other vehicles to prevent or minimize the collision.
